(19) United States
(12) Patent Application Publication
(10) Pub. No.: US 2026/0171476 A1
(43) Pub. Date: Jun. 18, 2026

(54) ANODELESS ALL SOLID STATE BATTERY AND METHOD FOR MANUFACTURING THE SAME

(71) Applicants: HYUNDAI MOTOR COMPANY, Seoul (KR); KIA CORPORATION, Seoul (KR); Seoul National University R&DB Foundation, Seoul (KR)

(72) Inventors: Ji Young Kim, Hwaseong-si (KR); Sang Heon Lee, Hwaseong-si (KR); Sam Ick Son, Hwaseong-si (KR); Ki Yoon Bae, Hwaseong-si (KR); Jang Wook Choi, Seoul (KR); Ji Hoon Oh, Seoul (KR)

(73) Assignees: HYUNDAI MOTOR COMPANY, Seoul (KR); KIA CORPORATION, Seoul (KR); Seoul National University R&DB Foundation, Seoul (KR)

(21) Appl. No.: 19/209,743

(22) Filed: May 15, 2025

(30) Foreign Application Priority Data
Dec. 16, 2024 (KR) 10-2024-0187737

(51) Int. Cl. H01M 10/0525; H01M 4/134; H01M 10/0562

(52) U.S. Cl. CPC H01M 10/0525; H01M 4/134; H01M 10/0562

(57) ABSTRACT

An anodeless all solid state battery includes an anode current collector, a first intermediate layer disposed on the anode current collector and including lithium alloy-based metal, a second intermediate layer disposed on the first intermediate layer, and including lithium non-alloying metal and a solid electrolyte, a solid electrolyte layer disposed on the second intermediate layer, a cathode active material layer disposed on the solid electrolyte layer, and a cathode current collector disposed on the cathode active material layer.

### CROSS-REFERENCE TO RELATED APPLICATION

This application claims the benefit of priority to Korean Patent Application No. 10-2024-0187737, filed in the Korean Intellectual Property Office on Dec. 16, 2024, the entire contents of which are incorporated herein by reference.

### TECHNICAL FIELD

The present disclosure provides an anodeless all solid state battery, which includes an intermediate layer to precipitate lithium, and a method for manufacturing the same.

### BACKGROUND

A secondary battery, which is rechargeable, finds use not only in a smaller electronic device, such as a mobile phone or a laptop computer, but also in a larger transportation, such as a hybrid vehicle or an electric vehicle. These broad and various applications creates a continuing need to develop a secondary battery having higher stability and an energy density, relative to the state of the art.

For a conventional secondary battery, a cell is typically based on an organic solvent (or an organic liquid electrolyte). Accordingly, such a conventional secondary battery has limitations with respect to realizing improvements in stability and energy density. In contrast, an all solid state battery utilizing an inorganic solid electrolyte is based on technology avoids the use of organic solvent. Accordingly, solid state battery technology has been explored for its potential as a cell that can be manufactured in a more stable and simpler form, relative to liquid electrolyte based technology.

Typically, an all solid state battery includes a cathode active material layer bonded to a cathode current collector, an anode active material layer bonded to an anode current collector, and a solid electrolyte layer interposed between the anode active material layer and the cathode active material layer. Typically, the anode active material layer includes a solid electrolyte that transports lithium ions in addition to the anode active material, such as graphite, and the solid electrolyte has a specific gravity higher than a specific gravity of a liquid electrolyte. Accordingly, the energy density of the all solid state battery is typically lower than an energy density of a lithium ion battery that is based on a liquid electrolyte.

Some recent research has focused on ways to increase the energy density of an all solid state battery, and particularly incorporate an anodeless all solid state battery (i.e., without an anode active material layer) that can directly precipitate lithium ions on the anode current collector in the form of lithium metal. However, this research has demonstrates that when the anodeless all solid state battery is charged, lithium that is transmitted from the cathode is plated on the anode current collector and forms a lithium dendrite, which leads to poor battery performance and/or degradation.

### SUMMARY

The present disclosure has been made to solve the above-mentioned problems occurring in the state of the art while maintaining existing advantages that have been achieved in the art.

An aspect of the present disclosure provides an anodeless all solid state battery that avoids occurrence of an internal short circuit. In embodiments of this aspect of the anodeless all solid state battery, a lithium-plated layer is additionally formed between a solid electrolyte layer and an intermediate layer, which can provide for more stable charging/discharging performance even under conditions such as, for example, higher current density of at least 3.0 mA/cm².

The aforementioned technical problems are solved by the present disclosure, the aspects and embodiments are not limited only to those specific problems, and any other technical problems the disclosure can address, and not mentioned herein explicitly, will be clearly understood by those skilled in the art to which the present disclosure pertains based on the full scope of the following description.

An aspect of the present disclosure provides an anodeless all solid state battery which includes an anode current collector, a first intermediate layer disposed on (e.g., disposed on at least a portion of) the anode current collector and including lithium alloy-based metal, a second intermediate layer disposed on (e.g., disposed on at least a portion of) the first intermediate layer, and including lithium non-alloying metal and a solid electrolyte, a solid electrolyte layer disposed on (e.g., disposed on at least a portion of) the second intermediate layer, a cathode active material layer disposed on (e.g., disposed on at least a portion of) the solid electrolyte layer, and a cathode current collector disposed on (e.g., disposed on at least a portion of) the cathode active material layer.

An aspect of the present disclosure provides a method for manufacturing an anodeless all solid battery, which includes forming a first intermediate layer comprising lithium alloy-based metal on an anode current collector (S1), forming a second intermediate layer comprising lithium non-alloying metal and a solid electrolyte on the first intermediate layer, and forming a solid electrolyte layer on the second intermediate layer (S2), forming a cathode active material layer on the solid electrolyte layer (S3), and forming or disposing a cathode current collector on the cathode active material layer (S4).

### BRIEF DESCRIPTION OF THE DRAWINGS

The above aspects and embodiments as well as other objects, features and advantages of the present disclosure will be more apparent from the following detailed description taken in conjunction with the accompanying drawings:

FIG. 1 depicts a schematic view illustrating the driving state of an anodeless all solid state battery according to an embodiment of the present disclosure;

FIG. 2 illustrates an SEM image and EDS mapping for a cross-section of an electrode plated with lithium according to an embodiment of the present disclosure;

FIG. 3 depicts a view illustrating an interface of a lithium non-alloying metal-solid electrolyte composite layer formed on an electrode according to an embodiment of the present disclosure;

FIG. 4 illustrates graphs representing a measurement result of energy of tungsten (W) on a lithium surface;

FIG. 5 illustrates graphs representing a measurement result of energy of chromium (Cr) on a lithium surface;

FIG. 6 illustrates graphs representing a measurement result of energy of molybdenum (Mo) on a lithium surface;

FIG. 7 illustrates graphs representing a measurement result of energy of titanium (Ti) on a lithium surface;

FIG. 8 illustrates graphs representing a measurement result of energy of zirconium (Zr) on a lithium surface;

FIG. 9 depicts a graph illustrating the profile of a current density applied to a half-cell including an electrode according to an embodiment of the present disclosure and a comparative example;

FIGS. 10, 11, and 12 depict graphs illustrating the profile of a current density applied to a half-cell including an electrode according to an embodiment of the present disclosure and a comparative example;

FIG. 13 depicts a graph illustrating a coulombic efficiency measured for each cycle with respect to a half-cell including an electrode according to an embodiment of the present disclosure and a comparative example;

FIG. 14 depicts a graph illustrating a voltage-specific capacity measured in an initial charging/discharging process with respect to a full cell including an electrode according to an embodiment of the present disclosure;

FIG. 15 depicts a graph illustrating a specific capacity and a coulombic efficiency with respect to a full cell including an electrode according to an embodiment of the present disclosure; and

FIG. 16 depicts a graph representing a voltage-specific capacity corresponding to 1^{st} cycle and 100^{th} cycle with respect to a full cell including an electrode according to an embodiment of the present disclosure.

### DETAILED DESCRIPTION

Hereinafter, the present disclosure will be described in more detail for the understanding of the present disclosure.

Unless defined otherwise by the disclosure, all technical and scientific terms used herein should be given their ordinary and customary meaning as commonly understood by one of ordinary skill in the art to which the disclosure belongs. A number of terms and abbreviations appear throughout the disclosure and, unless otherwise defined or indicated, should be understood to have their reasonably broad commonly understood and plain meanings that are consistent with the context in which the terms are used.

As used herein, referent terms such as “first,” “second,” “initial,” “subsequent,” and the like, may be used for describing various components, but the components are not limited by the terms. These terms are only used to distinguish one component from another component. For example, without departing from the scope of the present disclosure, a first component may be named as a second component, and similarly, a second component may be named as a first component.

The terms used in the present disclosure are provided only for the illustrative purpose, and the present disclosure is not limited thereto. The singular forms are intended to include the plural forms unless the context clearly indicates otherwise.

In this specification, It will be further understood that the terms “comprises,” “includes,” or “has,” specify the presence of stated features, numbers, steps, components, parts, or the combination thereof, but do not preclude the presence or addition of one or more other features, numbers, steps, components, and/or the combination thereof. These terms should be understood to be inclusive of terms including “consisting of” and “consisting essentially of” which refer to features, numbers, steps, components, parts, or combinations thereof that only include the recited components, and allowing for minor amounts of other components or elements that do not have a material effect on the function of the recited feature or component(s).

### <Anodeless All Solid State Battery>

In an aspect, the present disclosure provides an anodeless all solid state battery.

According to an embodiment of the present disclosure, an anodeless all solid state battery comprises at least an anode current collector, a first intermediate layer comprising lithium alloy-based metal disposed on at least a portion of the anode current collector, a second intermediate layer comprising lithium non-alloying metal and a solid electrolyte disposed on at least a portion of the first intermediate layer, a solid electrolyte layer disposed on at least a portion of the second intermediate layer, a cathode active material layer disposed on at least a portion of the solid electrolyte layer, and a cathode current collector disposed on at least a portion of the cathode active material layer.

In general, an all solid state battery includes an anode active material layer bonded to an anode current collector, a cathode active material layer bonded to a cathode current collector, and a solid electrolyte layer interposed between the anode active material layer and the cathode active material layer. However, in accordance with embodiments of the disclosure the anode active material layer includes a solid electrolyte that can move/transport lithium ions in addition to the anode active material, such as graphite, and wherein the solid electrolyte has a specific gravity higher than a specific gravity of, e.g., a liquid electrolyte. Accordingly, in such embodiments the all solid state battery has an energy density that is lower than an energy density of a lithium ion battery that includes liquid electrolyte.

Recent studies and research that attempt to increase energy density of solid state batteries have pursued an anodeless all solid state battery in a storage type to directly precipitate lithium ions on the anode current collector in the form of lithium metal, without the anode active material layer.

A conventional anodeless all solid state battery includes an intermediate layer interposed between the solid electrolyte layer and the anode current collector and including a carbon material to uniformly precipitate and plate lithium. When charging the anodeless all solid state battery, lithium ions (Li+) of the cathode reach the intermediate layer through the solid electrolyte layer. The lithium ions (Li+) react with the carbon material, move, and then are precipitated between the anode current collector and the intermediate layer. However, when typical graphite is included as a carbon material in the intermediate layer of the anodeless all solid state battery, active lithium is consumed due to uncontrolled lithium dendritic growth and a side reaction. Lithium ions are precipitated between the solid electrolyte layer and the intermediate layer due to the crystallinity of graphite, thereby causing an internal short circuit. Accordingly, the lifespan of these anodeless all solid state battery may be shortened.

According to an embodiment of the present disclosure, the anodeless all solid state battery includes a first intermediate layer including lithium alloy-based metal that can stably plate lithium, and a second intermediate layer to induce lithium to be plated on the first intermediate layer and to allow the plated lithium metal to react with the solid electrolyte layer. This structure can prevent lithium dendritic growth, and thereby, prevent internal short circuits, as the lithium-plated layer is additionally formed between the solid electrolyte layer and an intermediate layer. The structure also allows for stable charging/discharging performance under conditions of a higher current density of at least 3.0 mA/cm².

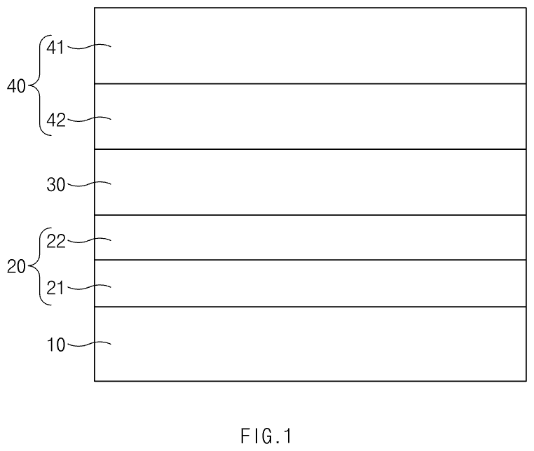

Hereinafter, components comprising the anodeless all solid state battery according to an embodiment of the present disclosure will be described with reference to FIG. 1 in some detail. FIG. 1 is a view schematically illustrating the driving state of an anodeless all solid state battery according to an embodiment of the present disclosure.

### Anode Current Collector

According to an embodiment of the present disclosure, an anode current collector 10, which serves as a generally plate-shaped substrate having electrical conductivity, may include a material which does not react with lithium. In some embodiments, the anode current collector 10 can include various materials without being particularly limited, as long as the materials have conductivity but do not induce a chemical change in the battery (or the anodeless all solid state battery according to the present disclosure). For example, in some non-limiting embodiments, the anode current collector 10 may be at least one of aluminum (Al), nickel (Ni), titanium (Ti), tungsten (W), iron (Fe), chromium (Cr), and/or stainless steel, or an alloy thereof.

### Intermediate Layer

According to an embodiment of the present disclosure, an intermediate layer 20, is directly disposed (e.g., bonded, layered, formed, etc.) on the anode current collector 10, and may induce lithium metal to be plated in a horizontal direction along the surface (e.g., in a generally uniform layer along the surface) of the anode current collector 10, (i.e., when lithium ions are precipitated in the form of lithium metal on the surface of the anode current collector 10).

According to an embodiment of the present disclosure, the intermediate layer 20 may include a first intermediate layer 21 and a second intermediate layer 22 disposed on the first intermediate layer 21.

According to an embodiment of the present disclosure, the first intermediate layer 21, which is directly disposed on the anode current collector 10, may act as a surface for plating lithium in a charging process of the anodeless all solid state battery.

According to an embodiment of the present disclosure, the first intermediate layer 21 may include lithium alloy-based metal that can react with lithium ions to form an alloy with lithium. Accordingly, in such embodiments, the plating of lithium may be performed on the first intermediate layer 21 in the charging process of the anodeless all solid state battery.

According to an embodiment of the present disclosure, the lithium alloy-based metal may include at least one of tin (Sn), cadmium (Cd), silver (Ag), gold (Au), platinum (Pt), palladium (Pd), magnesium (Mg), and/or zinc (Zn), or a combination thereof. In some specific embodiments, the lithium alloy-based metal may be at least one selected from the group consisting of magnesium (Mg), zinc (Zn), silver (Ag), gold (Au), and/or a combination thereof. In further embodiments, the lithium alloy-based metal may be magnesium (Mg).

According to an embodiment of the present disclosure, the first intermediate layer 21 may be manufactured (e.g., prepared, deposited, disposed, layered, contacted to/on the anode current collector) in a manner such as a sputtering manner or a chemical vapor deposition manner.

According to an embodiment of the present disclosure, the first intermediate layer 21 may have a thickness ranging from 1 nm to 1,000 nm. In some specific embodiments, the first intermediate layer 21 may be at least 10 nm, at least 20 nm, at least 30 nm, at least 40 nm, at least 50 nm, and at most 900 nm, at most 800 nm, at most 700 nm, at most 600 nm, at most 500 nm, or at most 400 nm. When the thickness of the first intermediate layer 21 satisfies the above ranges, the lithium may be more effectively plated.

According to an embodiment of the present disclosure, the second intermediate layer 22, which is directly disposed on the first intermediate layer 21, may induce lithium ions to be plated on the first intermediate layer 21 and prevent the solid electrolyte layer 30 from making direct contact with any lithium plating, thereby preventing formation of any dendritic lithium.

According to an embodiment of the present disclosure, the second intermediate layer 22 may include lithium non-alloying metal, which does not react with the lithium ions to form an alloy. Accordingly, the lithium ions may be plated on the first intermediate layer 21 instead of the second intermediate layer 22. Accordingly, as the lithium ions are not plated on the second intermediate layer 22, lithium ion plating may be prevented from making direct contact with the solid electrolyte layer 30.

According to an embodiment of the present disclosure, the second intermediate layer 22 including the lithium non-alloying metal is provided in the form of a layer separate from the first intermediate layer 21, thereby preventing the lithium ions from being plated between the solid electrolyte layer 30 and the intermediate layer 20. When the lithium non-alloying metal is mixed with the lithium alloy-based metal to provide one layer, the lithium ion plating may make direct contact with the solid electrolyte layer 30 and may form lithium dendrite(s), which can lead to an internal short circuit.

According to an embodiment of the present disclosure, the lithium non-alloying metal, which has lithium interfacial energy greater than 0 meV/Å², may be at least one of nickel (Ni), titanium (Ti), manganese (Mn), iron (Fe), cobalt (Co), tungsten (W), chromium (Cr), molybdenum (Mo), zirconium (Zr), and/or a combination thereof. In some specific embodiments, the lithium non-alloying metal may be at least one selected from the group consisting of tungsten (W), chromium (Cr), molybdenum (Mo), titanium (Ti), and zirconium (Zr), and any combination thereof, and in yet further embodiments, may be tungsten (W).

According to an embodiment of the present disclosure, the second intermediate layer 22, comprising a lithium non-alloying metal-solid electrolyte composite layer, may include a solid electrolyte. The solid electrolyte may apply ion conductivity and electrical conductivity in an appropriate range to the second intermediate layer 22, thereby inducing the lithium ions to be plated on the first intermediate layer 21. The solid electrolyte can be the same solid electrolyte that is used for the solid electrolyte layer 30 which is described below in detail.

According to an embodiment of the present disclosure, the ion conductivity of the second intermediate layer 22 may be at least 1.0×10⁻⁵ S/cm, and in more specific embodiments may be at least 1.5×10⁻⁵ S/cm, at least 2.0×10⁻⁵ S/cm, at least 2.5×10⁻⁵ S/cm, at least 3.0×10⁻⁵ S/cm, or at least 3.5×10⁻⁵ S/cm. When the ion conductivity of the second intermediate layer 22 falls within the above range, the lithium ions may be more easily plated on the first intermediate layer 21. In embodiments, ion conductivity can be calculated by measuring bulk resistance using EIS (electrochemical impedance spectroscopy), or any other method known in the art.

According to an embodiment of the present disclosure, the electronic conductivity of the second intermediate layer 22 may be at least 1.0×10⁻⁵ S/cm, and in more specific embodiments may be at least 9.0×10⁻⁶ S/cm, at least 8.0×10⁻⁶ S/cm, at least 7.0×10⁻⁶ S/cm, at least 6.0×10⁻⁶ S/cm, or at least 5.0×10⁻⁶ S/cm. When the electronic conductivity of the second intermediate layer 22 falls within the above range, the lithium ions may be more easily plated on the first intermediate layer 21. In embodiments, electronic conductivity can be calculated by measuring the resistivity of a pellet formed by compressing solid electrolyte powder, using the four-point probe technique, or any other method known in the art.

According to an embodiment of the present disclosure, the second intermediate layer 22 may be manufactured (e.g., prepared, deposited, disposed, layered, contacted to/on the first intermediate layer) by mixing the lithium non-alloying metal and the solid electrolyte and performing a spin coating process, or a sputtering deposition process with respect to the mixture (hereinafter, referred to as “illustrative manufacturing method 1”). Alternatively, the second intermediate layer 22 may be manufactured by depositing the lithium non-alloying metal on the first intermediate layer 21 through a deposition process, such as a sputtering deposition process, to form a lithium non-alloying metal layer, by separately forming the solid electrolyte layer 30, and by pressing the solid electrolyte layer 30 at a hig pressure (e.g., of at least 300 MPa), such that a portion of the solid electrolyte, which is included in the solid electrolyte layer 30, is infiltrated into (i.e., interspersed) the lithium non-alloying metal layer (hereinafter, referred to as “illustrative manufacturing method 2”) Further details are be provided in the description regarding a method for manufacturing an anodeless all solid state battery, according to an embodiment of the present disclosure.

According to an embodiment of the present disclosure, when the second intermediate layer 22 is manufactured through illustrative manufacturing method 2, the lithium non-alloying metal may be uniformly aligned and mixed with the solid electrolyte in the second intermediate layer 22. Accordingly, an interface resistance may be more effectively reduced.

According to an embodiment of the present disclosure, when the second intermediate layer 22 is manufactured through illustrative manufacturing method 2, the concentration of the solid electrolyte included in the second intermediate layer 22 may be increased, as the second intermediate layer 22 approaches a surface adjacent to the solid electrolyte layer 30.

According to an embodiment of the present disclosure, the second intermediate layer 22 may have a thickness ranging from 1 nm to 10,000 nm. In some specific embodiments, the second intermediate layer 22 may be at least 10 nm, at least 20 nm, at least 30 nm, at least 40 nm, at least 50 nm, and at most 900 nm, at most 800 nm, at most 700 nm, at most 600 nm, at most 500 nm, or at most 400 nm. When the thickness of the second intermediate layer 22 falls within the above ranges, the lithium may be more effectively plated.

### Solid Electrolyte Layer

According to an embodiment of the present disclosure, the anodeless all solid state battery may include a solid electrolyte layer 30. The solid electrolyte layer 30 may be interposed between a cathode active material layer 42 and the intermediate layer 20 to transfer lithium ions which are present between the cathode active material layer 42 and the anode current collector 10.

According to an embodiment of the present disclosure, the solid electrolyte layer 30 may be disposed on the intermediate layer 20 and may include a solid electrolyte having lithium ion conductivity. In embodiments, the solid electrolyte can include at least one of an oxide-based solid electrolyte, a sulfide-based solid electrolyte, a polymer electrolyte, and/or a combination thereof, and in some preferred embodiments may include a sulfide-based solid electrolyte.

According to an embodiment of the present disclosure, the sulfide-based solid electrolyte may include at least one of Li₆PS₅X (where X=at least one selected of Cl, Br and/or I), Li₁₀GeP₂S₁₂, Li₃PS₄, Li₇P₃S₁₁, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZₘSₙ(where ‘m’ and ‘n’ are each positive numbers; and Z is one of Ge, Zn, and/or Ga), Li₂S—GeS₂, Li₂S—SiS₂—Li₃PO₄, Li₂S—SiS₂—LiₓMO_{y} (where ‘x’ and ‘y’ are each positive numbers; and M is one of P, Si, Ge, B, Al, Ga, and/or In), and any combination thereof.

### Cathode

According to an embodiment of the present disclosure, a cathode 40 may include a cathode current collector 41 and the cathode active material layer 42.

The cathode current collector 41 can include various materials without being particularly limited, as long as the materials have conductivity without inducing a chemical change in the battery. In some example embodiments, the cathode current collector 41 may be at least one of aluminum (Al), nickel (Ni), titanium (Ti), tungsten (W), iron (Fe), chromium (Cr), and/or stainless steel, or an alloy thereof.

According to an embodiment of the present disclosure, the cathode active material layer 42 may include a cathode active material, a conductive material, and a binder.

According to an embodiment of the present disclosure, the cathode active material, which allows lithium ions (Li⁺) to be reversibly plated and/or released, may include a composite oxide (or a lithium composite metal oxide) of lithium and metal. For example, in some embodiments, the lithium composite metal oxide may be a lithium-manganese-based oxide (e.g., LiMnO₂ or LiMn₂O₄), a lithium-cobalt-based oxide (e.g., LiCoO₂), a lithium-nickel-based oxide (e.g., LiNiO₂), a lithium-nickel-manganese-based oxide (e.g., LiNi_{1-Y}Mn_{Y}O₂ (where 0<Y<1), or LiMn_{2-Z}Ni_{Z}O₄ (where 0<Z<2)), a lithium-nickel-cobalt-based oxide (e.g., LiNi_{1-Y1}Co_{Y1}O₂ (where 0<Y1<1)), a lithium-manganese-cobalt-based oxide (e.g., LiCo_{1-Y2}Mn_{Y2}O₂ (where 0<Y2<1), or LiMn_{2-Z1}Co_{Z1}O₄ (where 0<Z1<2)), a lithium-nickel-manganese-cobalt-based oxide (e.g., Li(NiₚCo_{q}Mnᵣ₁)O₂ (where 0<p<1, 0<q<1, 0<r1<1, and p+q+r1=1) or Li(Niₚ₁Co_{q1}Mnᵣ₂)O₄ (where 0<p1<2, 0<q1<2, 0<r2<2, and p1+q1+r2=2)), or a lithium-nickel-cobalt-transition metal (M) oxide (e.g., Li(Niₚ₂Co_{q2}Mnᵣ₃M_{S2})O₂ (where ‘M’ is selected from the group consisting of Al, Fe, V, Cr, Ti, Ta, Mg, and Mo; p2, q2, r3 and s2 are atomic fractions of independent elements; 0<p2<1, 0<q2<1, 0<r3<1, 0<s2<1, p2+q2+r3+s2=1)), or may include any one of the above materials or a compound including at least two of the above materials.

Among the above exemplary embodiments, in further embodiments, the lithium composite metal oxide may be LiCoO₂, LiMnO₂, LiNiO₂, a lithium nickel manganese cobalt oxide (e.g., Li(Ni_{1/3}Mn_{1/3}Co_{1/3})O₂, Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂ and Li(Ni_{0.8}Mn_{0.1}Co_{0.1})O₂), or a lithium nickel cobalt aluminum oxide (e.g., Li(Ni_{0.8}Co_{0.15}Al_{0.05})O₂) to enhance a capacity characteristic and stability of a battery. When considering an effect remarkably improved by controlling the type and content ratio of components forming the lithium composite metal oxide, some embodiments provide for the lithium nickel manganese cobalt oxide to be Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂, and Li(Ni_{0.8}Mn_{0.1}Co_{0.1})O₂, or any one of the above materials, or a mixture of at least two of the above materials.

According to an embodiment of the present disclosure, the cathode active material may include boron (B) or LiNbO, and may further include a coating layer surrounding the lithium composite metal oxide. In embodiments wherein the coating layer is further included, the structural stability of the cathode active material may be improved.

In addition, according to an embodiment of the present disclosure, the cathode active material layer 42 may further include a solid electrolyte. In such embodiments, the solid electrolyte may coat the cathode active material. Accordingly, the interfacial compatibility between the cathode active material layer 42 and the solid electrolyte layer 30 (described below) may be improved. The solid electrolyte is detailed in the above description of the solid electrolyte layer 30.

According to an embodiment of the present disclosure, the conductive material may further improve the conductivity of the cathode active material. The conductive material may include various materials without being particularly limited, as long as the materials have conductivity without inducing a chemical change in the battery. In some example embodiments, the conductive material may include graphite; a carbon-based material, such as carbon black, acetylene black, ketjen black, channel black, furnace black, lamp black, thermal black, and SC65; a conductive fiber such as a carbon fiber or a metal fiber; metal powders such as carbon fluoride, aluminum or nickel powders; conductive whisker such as a zinc oxide or a potassium titanate; a conductive metal oxide such as a titanium oxide; and a conductive material, such as a polyphenylene derivative.

According to an embodiment of the present disclosure, the binder may facilitate bonding between the conductive material, the cathode active material, and the cathode current collector. The binder, in some embodiments, may be polyvinylidene fluoride, polyvinyl alcohol, carboxymethylcellulose, starch, hydroxypropylcellulose, regenerated cellulose, polyvinylpyrrolidone, tetrafluoroethylene, polyethylene, polypropylene, ethylene-propylene-diene monomer, sulfonated ethylene-propylene-diene monomer, styrene-butadiene rubber, nifril-butadiene rubber, fluorine rubber, and/or various copolymers thereof.

### <Method for Manufacturing Anodeless All Solid State Battery>

In an aspect, the present disclosure provides a method for manufacturing an anodeless all solid state battery.

According to an embodiment of the present disclosure, a method for manufacturing an anodeless all solid battery at least includes forming a first intermediate layer 21 including lithium alloy-based metal and disposed on a anode current collector 10, and (S1), forming a second intermediate layer 22 including lithium non-alloying metal and a solid electrolyte disposed on the first intermediate layer 21,, and (forming/applying) a solid electrolyte layer 30 disposed on the second intermediate layer 22 (S2), forming a cathode active material layer 42 disposed on the solid electrolyte layer 30 (S3), and disposing a cathode current collector 41 on the cathode active material layer 42 (S4).

According to an embodiment of the present disclosure, ‘S2’ includes forming the second intermediate layer by depositing a mixture of the lithium non-alloying metal and the solid electrolyte, on the first intermediate layer (S2-1a), and disposing the solid electrolyte layer on the second intermediate layer (S2-1b).

According to an embodiment of the present disclosure, ‘S2-1a’ may be performed through a spin coating deposition process or a sputtering deposition process.

According to an embodiment of the present disclosure, ‘S2’ may include forming a lithium non-alloying metal layer including the lithium non-alloying metal, on the first intermediate layer (S2-2a), manufacturing the solid electrolyte layer (S2-2b), and disposing the solid electrolyte layer on the lithium non-alloying metal layer and pressing the solid electrolyte layer at pressure of at least 300 MPa (S2-2c). In such embodiments, the lithium non-alloying metal may be uniformly deposited and mixed with the solid electrolyte in the second intermediate layer 22. Accordingly, in such embodiments, the interfacial resistance may be more effectively reduced.

According to an embodiment of the present disclosure, ‘S2-2a’ may be performed through a sputtering deposition process.

According to another embodiment of the present disclosure, the pressure applied in ‘S2-2c’ may be at least 300 MPa. In some specific embodiments, the pressure may be at least 320 MPa, at least 340 MPa, at least 360 MPa, at least 380 MPa, or at least 400 MPa, or at most 600 MPa, at most 580 MPa, at most 560 MPa, at most 540 MPa, at most 520 MPa, or at most or 500 MPa. When the pressure applied falls within the above range, a portion of the solid electrolyte included in the solid electrolyte layer 30 may be easily incorporated or infiltrated into the lithium non-alloying metal layer.

Hereinafter, an illustrative embodiment of the present disclosure will be described in detail such that those skilled in the art may more easily reproduce any one or more of the aspects and embodiments of the present disclosure. It will be appreciated that the present disclosure may be implemented in various forms, and is not limited to particular embodiments described herein.

### Example 1

After preparing an anode current collector having a thickness of 10 μm and including SUS316, a magnesium (Mg) thin film having the thickness of 200 nm was formed on the surface of the anode current collector through a DC sputtering process. Thereafter, a tungsten (W) thin film having the thickness of 30 nm was formed on the surface of the magnesium (Mg) thin film through the DC sputtering process to prepare an electrode.

### Example 2

After preparing an anode current collector having a thickness of 10 μm and including SUS316, a magnesium (Mg) thin film having the thickness of 200 nm was formed on the surface of the anode current collector through a DC sputtering process. Thereafter, a chromium (Cr) thin film having the thickness of 30 nm was formed on the surface of the magnesium (Mg) thin film through the DC sputtering process to prepare an electrode.

### Example 3

After preparing an anode current collector having a thickness of 10 μm and including SUS316, a magnesium (Mg) thin film having the thickness of 200 nm was formed on the surface of the anode current collector through a DC sputtering process. Thereafter, a molybdenum (Mo) thin film having the thickness of 30 nm was formed on the surface of the magnesium (Mg) thin film through the DC sputtering process to form an electrode.

### Example 4

After preparing an anode current collector having a thickness of 10 μm and including SUS316, a magnesium (Mg) thin film having the thickness of 200 nm was formed on the surface of the anode current collector through a DC sputtering process. Thereafter, a titanium (Ti) thin film having the thickness of 30 nm was formed on the surface of the magnesium (Mg) thin film through the DC sputtering process to form an electrode.

### Example 5

After preparing an anode current collector having a thickness of 10 μm and including SUS316, a magnesium (Mg) thin film having the thickness of 200 nm was formed on the surface of the anode current collector through a DC sputtering process. Thereafter, a zirconium (Zr) thin film having the thickness of 30 nm was formed on the surface of the magnesium (Mg) thin film through the DC sputtering process to form an electrode.

### Comparative Example 1

After preparing an anode current collector having a thickness of 10 μm and including SUS316, a magnesium (Mg) thin film having the thickness of 200 nm was formed on the surface of the anode current collector through a DC sputtering process to form an electrode.

### Experimental Example 1

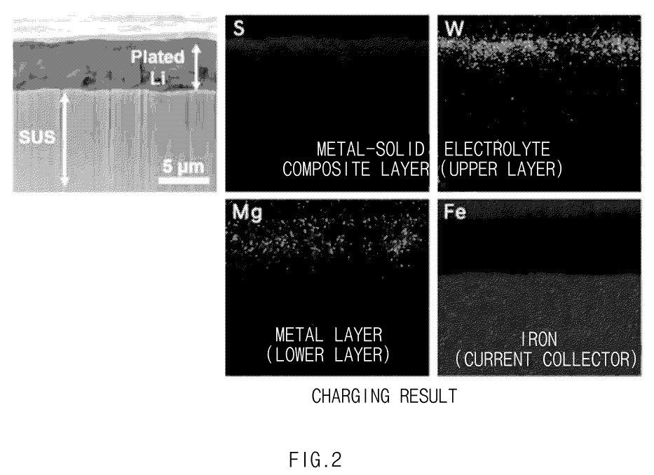

100 mg of the solid electrolyte Li₆PS₅Cl powder was put in a mold having an inner diameter of 10 mm and compressed to 120 MPa to form a solid electrolyte layer, and the solid electrolyte layer formed on the surface of the tungsten (W) thin film of the electrode formed in Example 1 was compressed at the pressure of 400 MPa to form an electrode including a lithium non-alloying metal-solid electrolyte composite layer (second intermediate layer). Thereafter, after lithium having a capacity of 1.0 mA/cm² was plated at a current density of 1.0 mA/cm² under the condition of 25° C. and 15 MPa, SEM images and EDS mapping of the electrode cross section are illustrated in FIG. 2 through an SEM-EDS. As SEM-EDS equipment, JSM-7800F Prime from JEOL was used.

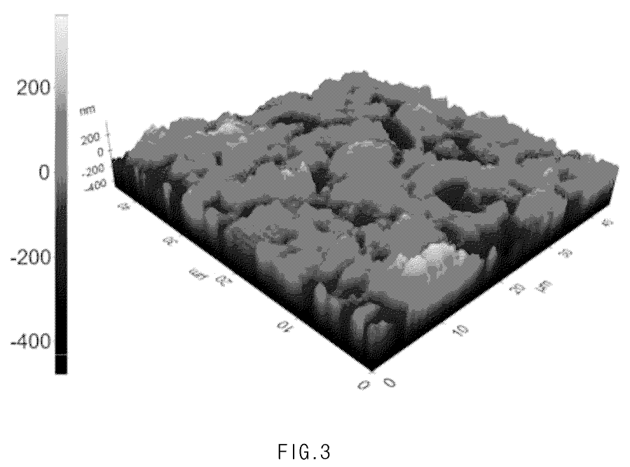

In addition, the surface of the lithium non-alloying metal-solid electrolyte composite layer (second intermediate layer) according to Example 1 was expressed in the form of an image through an atomic force microscope (AFM) equipped with a silicon nitride cantilever probe, XE-100, and park systems, and the image of the lithium non-alloying metal-solid electrolyte composite layer (second intermediate layer) is shown in FIG. 3.

Referring to FIG. 2, it may be recognized that lithium was plated on the Mg thin film layer, and lithium was not plated between the solid electrolyte layer and the lithium non-alloying metal-solid electrolyte composite layer. It may be expected that this was because tungsten (W) included in the lithium non-alloying metal-solid electrolyte composite layer is not reactive with lithium. Accordingly, it may be expected that a short circuit may be prevented from being caused as the solid electrolyte layer makes reaction with lithium ions. In addition, it may be recognized through energy-dispersive X-ray spectroscopy (EDS) mapping that tungsten (W) and sulfur(S) were distributed together in a region corresponding to lithium non-alloying metal-solid electrolyte composite layer, which is interpreted that the sulfide-based solid electrolyte was mixed inside the lithium non-alloying metal-solid electrolyte composite layer, due to the pressure applied while forming the solid electrolyte layer.

Referring to FIG. 3, it may be recognized that a pore variation equal to or greater than the particle size of the solid electrolyte was present on the interface of the lithium non-alloying metal-solid electrolyte composite layer. Accordingly, it may be expected that the solid electrolyte of the solid electrolyte layer 30 was infiltrated into the gap formed as the W thin film layer was cracked due to pressure applied to the solid electrolyte layer, and mixed, thereby forming the lithium non-alloying metal-solid electrolyte composite layer.

### Experimental Example 2

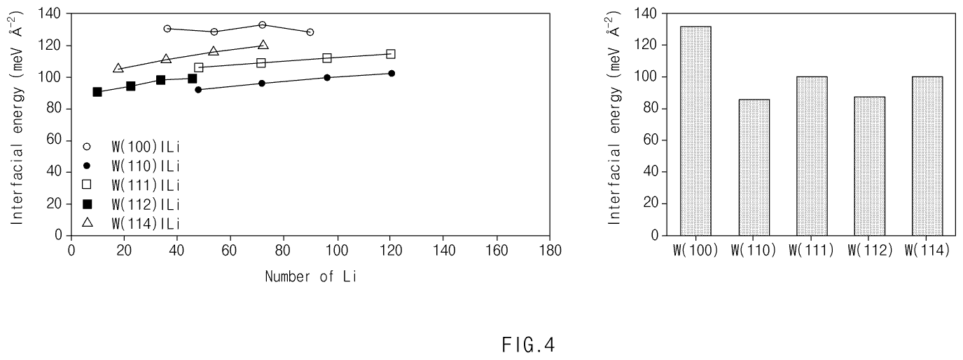

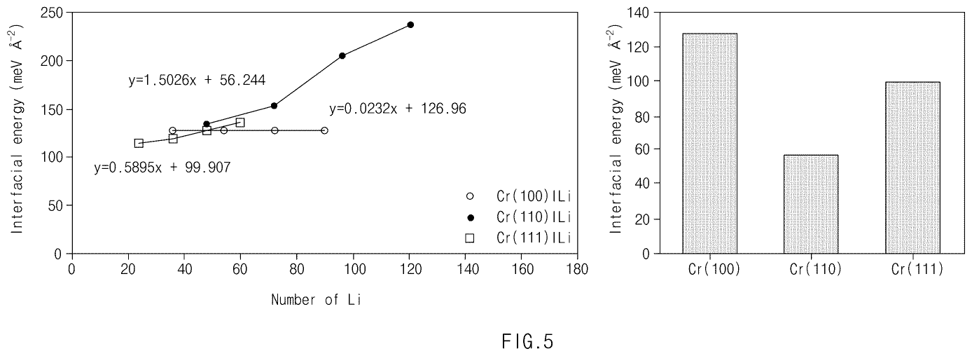

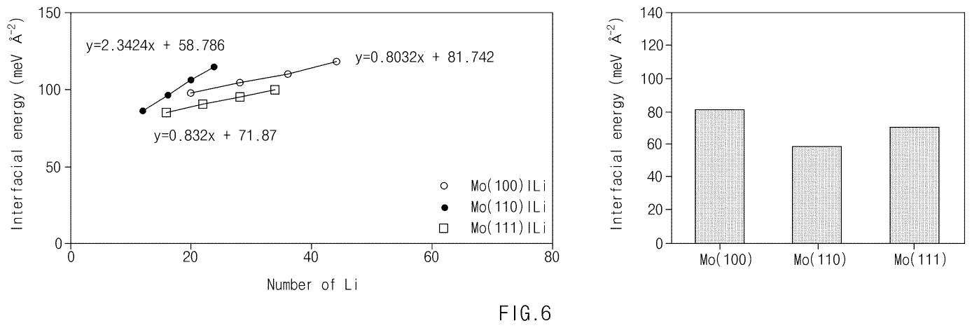

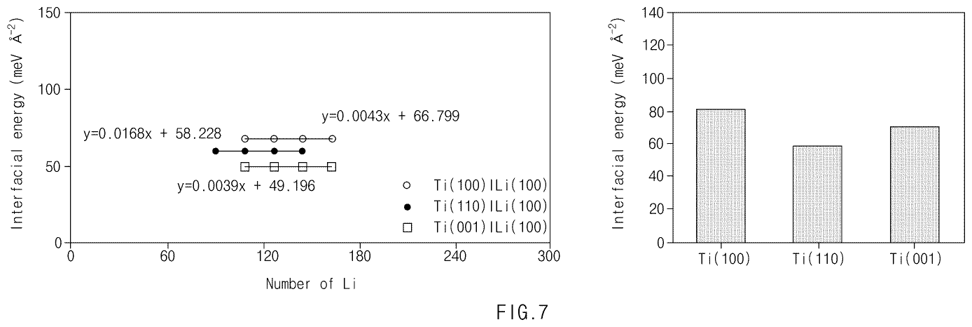

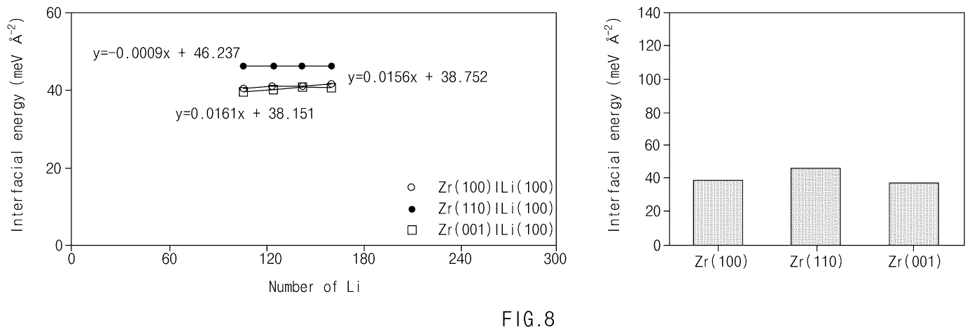

A chemical computation was performed with respect to elements included in second intermediate layers according to Example 1 to 5 through Vienna Ab initio Simulation Package (VASP) software, a Perdew-Burke-Ernzerhof (PBE) exchange-correlation function, and a projector reinforcement wave function. Thereafter, the lithium surface energy was calculated using the Density Function Theory (DFT) based on the cutoff energy of 520 eV and the grid spacing of 0.03 Å⁻¹ and the calculation result is illustrated in FIGS. 4 to 8.

Referring to FIGS. 4 to 8, it may be recognized that tungsten (W), chromium (Cr), molybdenum (Mo), titanium (Ti), and zirconium (Zr) all had lithium interfacial energy greater than 0 meV/Å², and thus were not alloyed with lithium.

### Experimental Example 3

100 mg of the solid electrolyte Li₆PS₅Cl powder was put in a mold having an inner diameter of 10 mm and compressed at 120 MPa to form a solid electrolyte layer, the solid electrolyte layer was disposed on the surface of the second intermediate layer according to each of Examples 1 to 5, and the result was compressed at 400 MPa. Thereafter, the lithium foil was compressed at 20 MPa on the solid electrolyte layer to manufacture a half-cell. Similarly, 100 mg of the solid electrolyte Li₆PS₅Cl powder was put in a mold having an inner diameter of 10 mm and compressed at 120 MPa to form a solid electrolyte layer, the solid electrolyte layer was disposed on the surface of the Mg thin film according to Comparative example 1, and the result was compressed at 400 MPa. Thereafter, the lithium foil was compressed at 20 MPa on the solid electrolyte layer to manufacture a half-cell.

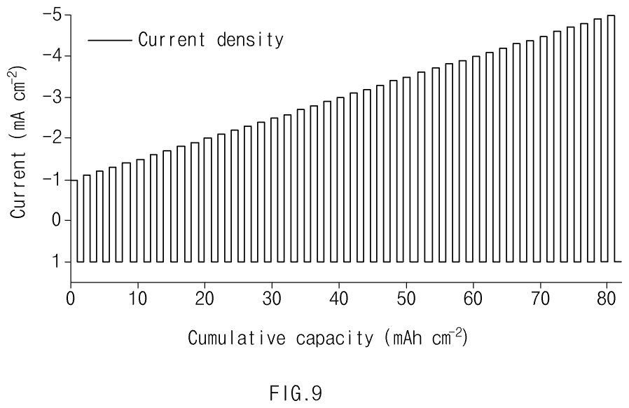

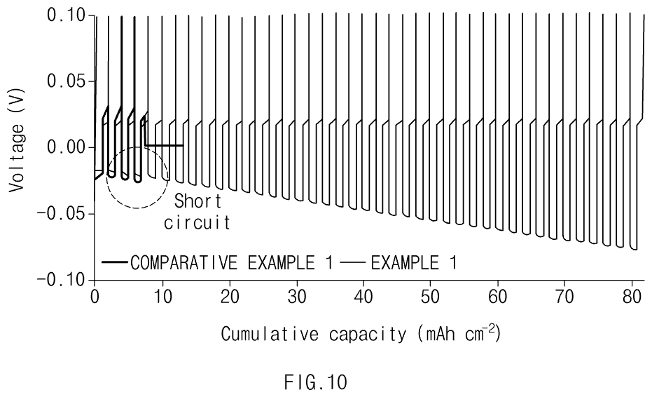

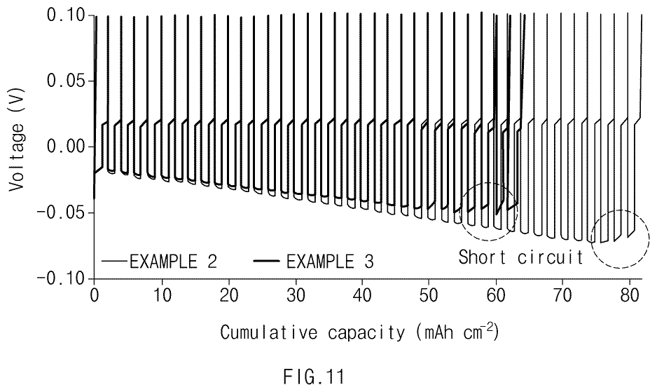

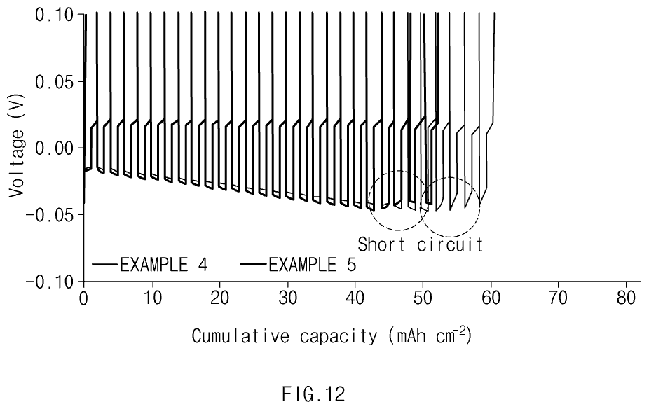

A current density as illustrated in FIG. 9 was applied to each of the manufactured half-cells, and the result is illustrated in FIGS. 10 to 12 Referring to FIG. 9, a negative current density, which indicates a plating process, was increased by 0.1 mA/cm² for each step from a current density of 1 mA/cm², and a positive current density, which indicates a stripping process, employed a fixed current density of 1 mA/cm². An amount of lithium plated was fixed to a capacity of 1 mAh/cm².

Referring to FIGS. 10 to 12, it may be recognized that all of the half-cells according to Examples 1 to 5 including the lithium non-alloying metal-solid electrolyte composite layer was improved to be at least 3.0 mA/cm² in a critical current density (CCD), and the half-cells according to Comparative Example 1 had lower critical current density, as compared to those of Examples 1 to 5.

### Experimental Example 4

100 mg of the solid electrolyte Li₆PS₅Cl powder was put in a mold having an inner diameter of 10 mm and compressed at 120 MPa to form a solid electrolyte layer, the solid electrolyte layer was disposed on the surface of the second intermediate layer according to Example 1, and the result was compressed at 400 MPa. Thereafter, the lithium foil was compressed at 20 MPa on the solid electrolyte layer to manufacture a half-cell. Similarly, 100 mg of the solid electrolyte Li₆PS₅Cl powder was put in a mold having an inner diameter of 10 mm and compressed at 120 MPa to form a solid electrolyte layer, the solid electrolyte layer was disposed on the surface of the Mg thin film according to Comparative example 1, and the result was compressed at 400 MPa. Thereafter, the lithium foil was compressed at 20 MPa on the solid electrolyte layer to manufacture a half-cell

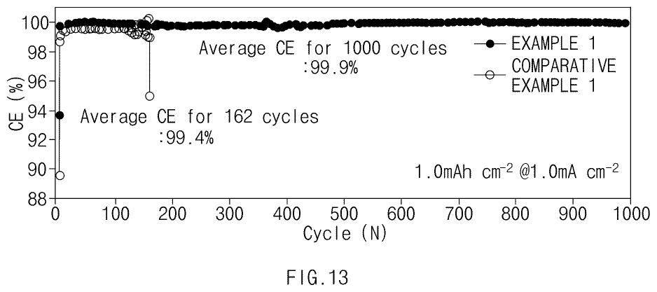

For each of the manufactured half-cells, lithium having a capacity of 1.0 mA/cm² was plated with a current density of 1.0 mA/cm² at a condition of 25° C. and 15 MPa. In addition, charging and discharging were repeatedly performed to 1,000^{th} cycle, on the assumption that one cycle was defined as the plating of lithium ions until a voltage reached 0.1 V at a current density of 1.0 mA/cm². In addition, a graph representing a Coulombic efficiency measured for each cycle is illustrated in FIG. 13.

Referring to FIG. 13, it may be recognized that an average Coulombic efficiency was 99.9% until the half-cell according to Example 1 reached 1,000^{th} cycle. In contrast, the half-cell according to Comparative Example 1 could not be driven due to an internal short circuit after the 162^{th} cycle.

### Experimental Example 5

100 mg of the solid electrolyte Li₆PS₅Cl powder was put in a mold having an inner diameter of 10 mm and compressed at 120 MPa to form a solid electrolyte layer.

In addition, 13 mg of powders of a cathode active material (LiNi_{0.8}Co_{0.1}Mn_{0.1}O₂), a solid electrolyte (Li₆PS₅Cl_{0.5}Br_{0.5}) and a conductive material (VGCF), which are mixed with each other at a ratio of 70:28:2, were put in a mold having an inner diameter of 10 mm and compressed at 200 MPa to form a cathode active material layer. A cathode current collector including aluminum (Al) and having the thickness of 10 μwas matched against one surface of the formed cathode active material, and the result was compressed at 380 MPa to manufacture a cathode.

Thereafter, the surface of the second intermediate layer according to Example 1 was disposed on one surface of the formed solid electrolyte layer, the surface of the manufactured cathode active material layer was disposed on an opposite surface of the solid electrolyte layer, and the result structure was compressed at 400 MPa to manufacture the anodeless all solid state battery. Similarly, the surface of the Mg thin film according to Comparative example 1 was disposed on one surface of the formed solid electrolyte layer, the surface of the manufactured cathode active material layer was disposed on an opposite surface of the solid electrolyte layer, and the result structure was compressed at 400 MPa to manufacture the anodeless all solid state battery.

Each anodeless all solid state battery which was manufactured was coupled to an evaluating jig at 20 MPa and evaluated as follows.

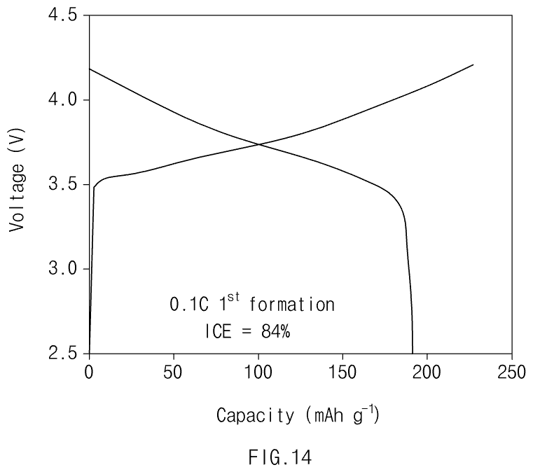

The anodeless all solid state battery according to Example 1 was charged at 0.1 C until 4.2 V in a constant current-constant voltage (CC-CV) mode at 25° C. and discharged at 0.1 C until 2.5 V to perform formation. The graph representing the relationship between a voltage and a specific capacity measured in the above process is illustrated in FIG. 14.

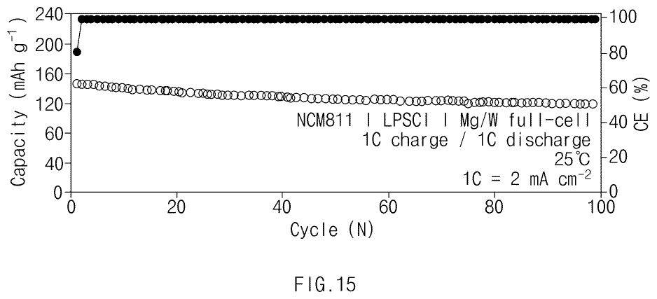

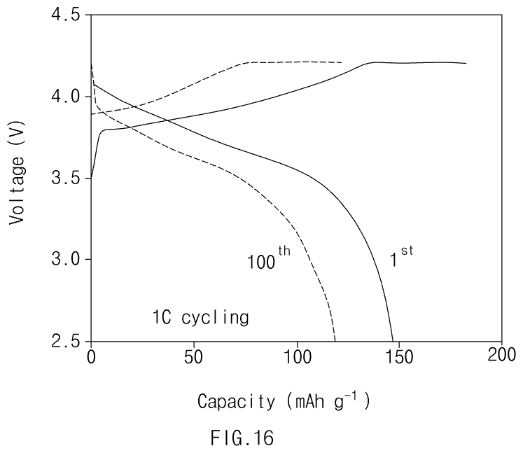

Thereafter, on the assumption that charging is performed at 1 C with 2 mA/cm² until 4.2 V, and discharging is performed at 1 C with 2 mA/cm² until 2.5 V, in the CC-CV mode at 25° C. for one cycle, the graph representing the relationship between a specific capacity and a coulomb efficiency per cycle measured is illustrated in FIG. 15. In addition, a graph representing the relationship between voltage and a specific capacity measured in 1^{st} cycle and 100^{th} cycle is illustrated in FIG. 16.

Referring to FIGS. 14 to 16, it may be recognized that the anodeless all solid state battery according to Example 1 was stably driven up to a 100^{th} cycle. In contrast, an anodeless all solid state battery according to Comparative example 1 immediately caused the internal short circuit and did not be driven under the condition of 1 C and 2 mA/cm². Accordingly, it is expected that the anodeless all solid state battery according to Example 1 prevents the internal short circuit from being caused due to the thin film including the lithium non-alloying metal according to Example 1.

As described above, according to an example of the present disclosure, in the anodeless all solid state battery, the internal short circuit is prevented from being caused as the lithium-plated layer is additionally formed between the solid electrolyte layer and the intermediate layer, and more stable charging/discharging may be performed even under the condition of higher current density of at least 3.0 mA/cm².

Hereinabove, although the present disclosure has been described with reference to exemplary examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An anodeless all solid state battery comprising:
an anode current collector;
a first intermediate layer comprising lithium alloy-based metal disposed on at least part of the surface of the anode current collector;
a second intermediate layer comprising lithium non-alloying metal and a solid electrolyte disposed on at least part of the surface of the first intermediate layer;
a solid electrolyte layer disposed on at least part of the surface of the second intermediate layer;
a cathode active material layer disposed on at least part of the surface of the solid electrolyte layer; and
a cathode current collector disposed on at least part of the surface of the cathode active material layer.

2. The anodeless all solid state battery of claim 1, wherein the lithium non-alloying metal has a lithium interfacial energy greater than 0 meV/Å².

3. The anodeless all solid state battery of claim 2, wherein the lithium non-alloying metal comprises at least one of nickel (Ni), titanium (Ti), manganese (Mn), iron (Fe), cobalt (Co), tungsten (W), chromium (Cr), molybdenum (Mo), zirconium (Zr), and/or a combination of nickel (Ni), titanium (Ti), manganese (Mn), iron (Fe), cobalt (Co), tungsten (W), chromium (Cr), molybdenum (Mo), or zirconium (Zr).

4. The anodeless all solid state battery of claim 1, wherein the second intermediate layer has a ion conductivity greater than or equal to 1.0×10⁻⁵ S/cm, and an electron conductivity less than or equal to 1.0×10⁻⁵ S/cm.

5. The anodeless all solid state battery of claim 1, wherein the second intermediate layer has a thickness ranging from 1 nm to 10,000 nm.

6. The anodeless all solid state battery of claim 1, wherein the second intermediate layer includes the lithium non-alloying metal and the solid electrolyte in a weight ratio ranging from 1:0.1 to 1:9 (lithium non-alloying metal: solid electrolyte).

7. The anodeless all solid state battery of claim 1, wherein the second intermediate layer has an increased concentration of the solid electrolyte near or at the surface adjacent to the solid electrolyte layer.

8. The anodeless all solid state battery of claim 1, wherein the lithium alloy-based metal comprises at least one of tin (Sn), cadmium (Cd), silver (Ag), gold (Au), platinum (Pt), palladium (Pd), magnesium (Mg), zinc (Zn), or a combination of tin (Sn), cadmium (Cd), silver (Ag), gold (Au), platinum (Pt), palladium (Pd), magnesium (Mg), and/or zinc (Zn).

9. The anodeless all solid state battery of claim 1, wherein the first intermediate layer has a thickness ranging from 1 nm to 10,000 nm.

10. The anodeless all solid state battery of claim 1, wherein the solid electrolyte included in the second intermediate layer is a sulfide-based solid electrolyte.

11. A method for manufacturing an anodeless all solid battery, the method comprising:
forming a first intermediate layer comprising lithium alloy-based metal on an anode current collector (S1);
forming a second intermediate layer comprising lithium non-alloying metal and a solid electrolyte, on the first intermediate layer, and forming a solid electrolyte layer on the second intermediate layer (S2);
forming a cathode active material layer on the solid electrolyte layer (S3); and
forming or disposing a cathode current collector on the cathode active material layer (S4).

12. The method of claim 11, wherein:
forming the second intermediate layer comprises depositing a mixture of the lithium non-alloying metal and the solid electrolyte, on the first intermediate layer (S2-1a); and
forming or disposing the solid electrolyte layer on the second intermediate layer (S2-1b).

13. The method of claim 11, wherein:
forming the second intermediate layer comprises disposing a lithium non-alloying metal layer on the first intermediate layer (S2-2a);
preparing the solid electrolyte layer (S2-2b); and
disposing the solid electrolyte layer on the lithium non-alloying metal layer and applying a pressure of at least 300 MPa to the solid electrolyte layer (S2-2c).

14. The anodeless all solid state battery of claim 8, wherein the lithium alloy-based metal comprises magnesium (Mg).

15. The anodeless all solid state battery of claim 3, wherein the lithium non-alloying metal comprises at least one of titanium (Ti), tungsten (W), chromium (Cr), molybdenum (Mo), or zirconium (Zr), or a combination of two or more of titanium (Ti), tungsten (W), chromium (Cr), molybdenum (Mo), and zirconium (Zr).

16. The anodeless all solid state battery of claim 1, wherein the lithium alloy-based metal comprises magnesium (Mg), and wherein the lithium non-alloying metal comprises at least one of titanium (Ti), tungsten (W), chromium (Cr), molybdenum (Mo), or zirconium (Zr), or a combination of two or more of titanium (Ti), tungsten (W), chromium (Cr), molybdenum (Mo), and zirconium (Zr).

17. The method of claim 11, wherein the lithium alloy-based metal comprises tin (Sn), cadmium (Cd), silver (Ag), gold (Au), platinum (Pt), palladium (Pd), magnesium (Mg), zinc (Zn), or a combination of tin (Sn), cadmium (Cd), silver (Ag), gold (Au), platinum (Pt), palladium (Pd), magnesium (Mg), and/or zinc (Zn).

18. The method of claim 17, wherein the lithium alloy-based metal comprises magnesium (Mg).

19. The method of claim 11, wherein the lithium non-alloying metal comprises at least one of titanium (Ti), tungsten (W), chromium (Cr), molybdenum (Mo), or zirconium (Zr), or a combination of two or more of titanium (Ti), tungsten (W), chromium (Cr), molybdenum (Mo), and zirconium (Zr).

20. The method of claim 11, wherein the lithium alloy-based metal comprises magnesium (Mg), and wherein the lithium non-alloying metal comprises at least one of titanium (Ti), tungsten (W), chromium (Cr), molybdenum (Mo), or zirconium (Zr), or a combination of two or more of titanium (Ti), tungsten (W), chromium (Cr), molybdenum (Mo), and zirconium (Zr).
